(19) United States
(12) Patent Application Publication
(10) Pub. No.: US 2023/0182508 A1
(43) Pub. Date: Jun. 15, 2023

(54) PNEUMATIC TIRE

(71) Applicant: TOYO TIRE CORPORATION, Itami-shi (JP)

(72) Inventor: Shinya Hasegawa, Itami-shi (JP)

(73) Assignee: TOYO TIRE CORPORATION, Itami-shi (JP)

(21) Appl. No.: 17/981,519

(22) Filed: Nov. 7, 2022

(30) Foreign Application Priority Data
Dec. 13, 2021 (JP) 2021-202009

(51) Int. Cl. B60C 15/06; C08F 36/08; C08K 3/06; C08K 3/04

(52) U.S. Cl. CPC B60C 15/0607; C08F 36/08; C08K 3/06; C08K 3/04; B60C 2200/06

(57) ABSTRACT

An object of the invention is to provide a pneumatic tire having excellent durability. In the pneumatic tire, a content of sulfur (US) in a rubber composition (U) used in an upper bead filler, a content of sulfur (LS) in a rubber composition (L) used in a lower bead filler, and a content of sulfur (PS) in a rubber composition (P) used in a pad satisfy the following Expression (1) and Expression (2).

4.0<LS-US<7.0 Expression (1)

4.0<LS-PS<7.0 Expression (2)

### BACKGROUND OF THE INVENTION

### 1. Field of the Invention

The present invention relates to a pneumatic tire.

### 2. Description of the Related Art

A pneumatic tire generally includes a pair of left and right beads, a pair of left and right sidewalls, and a tread provided between the sidewalls so as to connect radially outer end portions of the left and right sidewalls, a carcass layer embedded with fiber cords is mounted between the pair of left and right beads, and an end portion of the carcass layer is wound by being folded around a bead core and a bead filler from an inner side to an outer side.

Japanese Patent No. 6217326 discloses that a bead filler includes two members, an upper bead filler and a lower bead filler, and it is possible to provide a pneumatic tire having excellent bead durability by specifying a sulfur content and a modulus.

The pneumatic tire disclosed in Japanese Patent No. 6217326, however, has room for further improvement in durability.

### SUMMARY OF THE INVENTION

In view of the above points, an object of the invention is to provide a pneumatic tire having excellent durability.

Japanese Patent No. 6217326 discloses that a difference (SL-SU) between a sulfur content (SL) in the lower bead filler and a sulfur content (SU) in the upper bead filler is preferably less than 3, and that the bead durability after oven deterioration is insufficient when the difference is 3 or more.

A pneumatic tire according to the invention includes: a bead filler including two members, an upper bead filler and a lower bead filler; and a pad sandwiched between the upper bead filler and the sidewall and extending to a radially outer side of the upper bead filler, in which a rubber composition (U) containing a diene rubber (U1) and sulfur (U2) is used in the upper bead filler, a rubber composition (L) containing a diene rubber (L1) and sulfur (L2) is used in the lower bead filler, a rubber composition (P) containing a diene rubber (P1) and sulfur (P2) is used in the pad, and a content of the sulfur (U2) (US [parts by mass]) with respect to 100 parts by mass of the diene rubber (U1) in the rubber composition (U), a content of the sulfur (L2) (LS [parts by mass]) with respect to 100 parts by mass of the diene rubber (L1) in the rubber composition (L), and a content of the sulfur (P2) (PS [parts by mass]) with respect to 100 parts by mass of the diene rubber (P1) in the rubber composition (P) satisfy the following Expressions (1) and (2).

4.0<LS-US<7.0 Expression (1)

4.0<LS-PS<7.0 Expression (2)

A content of carbon black (CBU [parts by mass]) with respect to 100 parts by mass of the diene rubber (U1) in the rubber composition (U), a content of carbon black (CBL [parts by mass]) with respect to 100 parts by mass of the diene rubber (L1) in the rubber composition (L), and a content of carbon black (CBP [parts by mass]) with respect to 100 parts by mass of the diene rubber (P1) in the rubber composition (P) may satisfy the following Expression (3).

CBL>CBP>CBU Expression (3)

The content of the sulfur (US) in the rubber composition (U) and the content of the sulfur (PS) in the rubber composition (P) may satisfy the following Expression (4).

−1.0<US-PS<2.0 Expression (4)

The pneumatic tire according to the invention may be a heavy-duty pneumatic tire.

According to the pneumatic tire of the invention, excellent durability can be obtained.

### BRIEF DESCRIPTION OF THE DRAWINGS

FIG. 1 is a half cross-sectional view of a pneumatic tire according to one embodiment of the invention; and

FIG. 2 is an enlarged view of the vicinity of a bead of the pneumatic tire according to the embodiment of the invention.

### DESCRIPTION OF EMBODIMENTS

Hereinafter, matters related to embodiments of the invention will be described in detail.

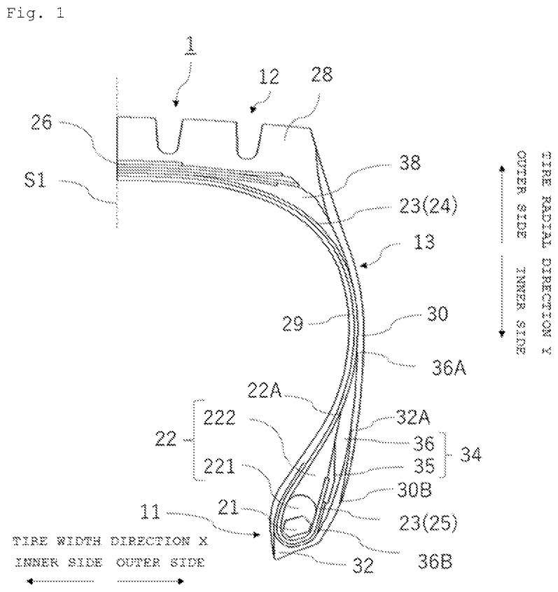

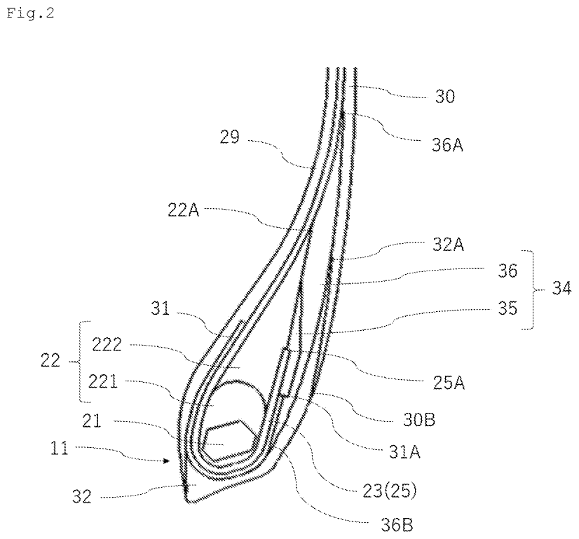

A pneumatic tire according to the present embodiment will be described with reference to FIGS. 1 and 2.

FIG. 1 is a diagram showing a half cross-section in a tire width direction of a tire 1 according to the present embodiment. A basic structure of the tire is left/right symmetric in the cross-section in the tire width direction, and therefore the right half of the cross section is shown here. In the figure, symbol S1 denotes a tire equatorial plane. The tire equatorial plane S1 is a plane orthogonal to a tire rotation axis and positioned at a center in the tire width direction.

Here, the tire width direction is a direction parallel to the tire rotation axis, and is a left-right direction of a drawing sheet in the cross-sectional view in FIG. 1. In FIG. 1, the tire width direction is illustrated as a tire width direction X.

Then, a tire width direction inner side is a direction approaching to the tire equatorial plane S1, and is the left side in the drawing sheet in FIG. 1. A tire width direction outer side is a direction away from the tire equatorial plane S1, and is the right side in the drawing sheet in FIG. 1.

In addition, a tire radial direction is a direction perpendicular to the tire rotation axis, and is an up-down direction in the drawing sheet in FIG. 1. In FIG. 1, the tire radial direction is illustrated as a tire radial direction Y.

Then, a tire radially outer side is a direction away from the tire rotation axis, and is the upper side in the drawing sheet in FIG. 1. A tire radially inner side is a direction approaching to the tire rotation axis, and is the lower side in the drawing sheet in FIG. 1.

The same applies to FIG. 2.

The tire 1 is, for example, a tire for a truck or a bus, and includes a pair of beads 11 provided at both sides in the tire width direction, a tread 12 that forms a ground contact surface with a road surface, and a pair of sidewalls 13 extending between the pair of beads 11 and the tread 12.

The bead 11 includes an annular bead core 21 formed by winding a plurality of times a metal bead wire covered with a rubber, and a tapered bead filler 22 extending to a tire radially outer side of the bead core 21. The bead filler 22 includes a lower bead filler 221 that covers an outer periphery of the bead core 21, and an upper bead filler 222 disposed at a tire radially outer side of the lower bead filler 221. The upper bead filler 222 is made of a rubber having a modulus higher than that of an inner liner 29 and a sidewall rubber 30, which will be described later. The lower bead filler 221 is made of a rubber having a modulus further higher than that of the upper bead filler 222. The lower bead filler 221 may not cover the outer periphery of the bead core 21 as long as at least a part of the lower bead filler 221 is disposed at the tire radially outer side of the bead core 21.

The bead core 21 is a member that plays a role of fixing a tire filled with air to a rim of a wheel (not shown). The bead filler 22 is a member provided to increase rigidity of a bead peripheral portion and ensure high maneuverability and stability.

A carcass ply 23, which constitutes a ply serving as a skeleton of the tire, is embedded inside the tire 1. The carcass ply 23 extends from one bead core to the other bead core. That is, the carcass ply 23 is embedded in the tire 1 in a manner of passing through the pair of sidewalls 13 and the tread 12 between the pair of bead cores 21.

As shown in FIG. 1, the carcass ply 23 includes a ply body 24 extending from one bead core to the other bead core and extending between the tread 12 and the bead 11, and a ply folded portion 25 folded around the bead core 21. Here, a folded end 25A of the ply folded portion 25 is positioned at a tire radially inner side of a tire radially outer end 22A of the bead filler 22.

The carcass ply 23 includes a plurality of ply cords extending in the tire width direction. In addition, the plurality of ply cords are arranged side by side in a tire circumferential direction.

This ply cord includes a metal steel cord, or an insulating organic fiber cord such as polyester or polyamide, and is covered with a rubber.

In the tread 12, a plurality of layers of steel belts 26 are provided at a tire radially outer side of the carcass ply 23. The steel belt 26 includes a plurality of steel cords covered with a rubber. By providing the steel belts 26, rigidity of the tire is ensured and a ground contact state between the tread 12 and the road surface is improved. In the present embodiment, four layers of steel belts 26 are provided, but the number of steel belts 26 to be laminated is not limited to this.

A tread rubber 28 is provided at a tire radially outer side of the steel belt 26. The tread rubber 28 is provided with a tread pattern (not shown) on an outer surface thereof, and this outer surface serves as a ground contact surface that comes into contact with the road surface.

In the vicinity of a tire width direction outer side of the tread 12, a shoulder pad 38 is provided in an area between the carcass ply 23 and the steel belt 26 as well as the tread rubber 28. This shoulder pad 38 extends to a tire radially outer area of the sidewall 13, and a part of the shoulder pad 38 forms an interface with the sidewall rubber 30, which will be described later. That is, in the tire radially outer area of the sidewall 13, a part of the shoulder pad 38 is present at a tire width direction inner side of the sidewall rubber 30.

The shoulder pad 38 is made of a rubber member having a cushioning property, and exerts as a cushion function between the carcass ply 23 and the steel belt 26. In addition, the shoulder pad 38 is made of a rubber having a low heat generation property, and therefore can effectively prevent heat generation by extending to the sidewall 13.

In the bead 11, the sidewall 13, and the tread 12, the inner liner 29 as a rubber layer that constitutes an inner wall surface of the tire 1 is provided at a tire inner cavity side of the carcass ply 23. The inner liner 29 is made of an air permeation resistant rubber and prevents the air inside the tire inner cavity from leaking to the outside.

In the sidewall 13, the sidewall rubber 30 that constitutes an outer wall surface of the tire 1 is provided at a tire width direction outer side of the carcass ply 23. This sidewall rubber 30 is a portion that flexes most when the tire acts as a cushion, and is generally made of a flexible rubber having fatigue resistance.

As shown in FIG. 2, a steel chafer 31 as a reinforcing ply is provided, in a manner of covering at least a part of the carcass ply 23, at a tire radially inner side of the carcass ply 23 provided around the bead core 21 of the bead 11. The steel chafer 31 also extends to a tire width direction outer side of the ply folded portion 25 of the carcass ply 23, and an end portion 31A of the steel chafer 31 is positioned at a tire radially inner side of the folded end 25A of the carcass ply 23.

This steel chafer 31 is a metal reinforcing layer made of metal steel cords and covered with a rubber.

A rim strip rubber 32 is provided at a tire radially inner side of the steel chafer 31. This rim strip rubber 32 is disposed along an outer surface of the tire and is connected to the sidewall rubber 30. A tire radially outer end 32A of the rim strip rubber 32 is positioned at a tire radially inner side of the tire radially outer end 22A of the bead filler 22. The rim strip rubber 32 and the sidewall rubber 30 are rubber members that constitute the outer surface of the tire.

A first pad 35 is provided at a tire radially outer side of the end portion 31A of the steel chafer 31 and at a tire width direction outer side of the folded portion 25 of the carcass ply 23 and the bead filler 22. This first pad 35 is provided at least at a tire width direction outer side of the folded end 25A of the carcass ply 23. The first pad 35 is formed in a manner of being tapered toward the tire radially outer side, and an end portion of the first pad 35 is positioned at a tire radially inner side of the tire radially outer end 32A of the rim strip rubber 32.

Further, a second pad 36 is provided so as to cover a tire width direction outer side of the first pad 35. More specifically, the second pad 36 is provided so as to cover a tire width direction outer side of a part of the steel chafer 31, the first pad 35, a part of the upper bead filler 222, and a part of the ply body 24 of the carcass ply 23. A tire radially outer end portion 36A of the second pad 36 extends to a radially outer side of the tire radially outer end 22A of the bead filler 22 and is positioned at a tire radially inner side of a tire maximum width position. In addition, a tire radially outer end portion 36B of the second pad 36 extends to a tire radially inner side of a tire radially inner end 30B of the sidewall rubber 30, and is not folded back around the bead core 21 from the tire width direction outer side to the tire width direction inner side.

The sidewall rubber 30 is disposed at a tire width direction outer side in a tire radially outer area of the second pad 36, and the rim strip rubber 32 is disposed at a tire width direction outer side in the tire radially inner area of the second pad 36.

In other words, the second pad 36 is provided between the first pad 35 and so on and the rim strip rubber 32 as well as the sidewall rubber 30, which are members that constitute the outer surface of the tire.

The first pad 35 and the second pad 36 constitute a pad member 34. The second pad 36 is made of a rubber having a modulus higher than that of the upper bead filler 222. The first pad 35 and the second pad 36 have a function of relieving sharp strain caused by a local rigidity change point at the folded end 25A of the carcass ply 23 and the end portion 31A of the steel chafer 31.

In the present embodiment, the pad member 34 includes the first pad 35 and the second pad 36. Alternatively, the pad member 34 may include one member.

Here, when reorganizing and explaining a relation between the rim strip rubber 32 and the members around the rim strip rubber 32, the rim strip rubber 32 is disposed at least at the tire width direction outer side of the ply folded portion 25 of the carcass ply 23 which is folded around the bead core 21. In the present embodiment, the rim strip rubber 32 covers a part of the pad member 34 at the tire width direction outer side, which is disposed at the tire width direction outer side of the folded portion 25 of the carcass ply 23. In addition, the sidewall rubber 30 covers a part of the rim strip rubber 32 at the tire width direction outer side and a part of the pad member 34 at the tire width direction outer side. By providing such a pad member 34, it is possible to effectively prevent stress concentration around a joint portion between the rim strip rubber 32 and the sidewall rubber 30.

The pneumatic tire according to the present embodiment is a pneumatic tire in which a rubber composition (U) containing a diene rubber (U1) and sulfur (U2) is used in the upper bead filler 222, a rubber composition (L) containing a diene rubber (L1) and sulfur (L2) is used in the lower bead filler 221, and a rubber composition (P) containing a diene rubber (P1) and sulfur (P2) is used in the second pad 36.

Here, a content of the sulfur (U2) (US [parts by mass]) with respect to 100 parts by mass of the diene rubber (U1) in the rubber composition (U), a content of the sulfur (L2) (LS [parts by mass]) with respect to 100 parts by mass of the diene rubber (L1) in the rubber composition (L), and a content of the sulfur (P2) (PS [parts by mass]) with respect to 100 parts by mass of the diene rubber (P1) in the rubber composition (P) satisfy the following Expressions (1) and (2).

4.0<LS-US<7.0 Expression (1)

4.0<LS-PS<7.0 Expression (2)

In addition, it is preferable that a content of carbon black (CBU) with respect to 100 parts by mass of the diene rubber (U1) in the rubber composition (U), a content of carbon black (CBL) with respect to 100 parts by mass of the diene rubber (L1) in the rubber composition (L), and a content of carbon black (CBP) with respect to 100 parts by mass of the diene rubber (P1) in the rubber composition (P) satisfy the following Expression (3).

CBL>CBP>CBU Expression (3)

In addition, it is preferable that the content of the sulfur (US) in the rubber composition (U) and the content of the sulfur (PS) in the rubber composition (P) satisfy the following Expression (4).

−1.0<US-PS<2.0 Expression (4)

<Rubber Composition (U) Used in Upper Bead Filler>

The rubber composition (U) according to the present embodiment contains the diene rubber (U1) as a rubber component, a type thereof is not particularly limited, and examples thereof include a natural rubber (NR), an isoprene rubber (IR), a butadiene rubber (BR), a styrene-butadiene rubber (SBR), a styrene-isoprene copolymer rubber, a butadiene-isoprene copolymer rubber, a styrene-isoprene-butadiene copolymer rubber, an acrylonitrile-butadiene rubber (NBR), a chloroprene rubber (CR), and a butyl rubber (IIR).

The rubber composition (U) according to the present embodiment contains the sulfur (U2), a type thereof is not particularly limited, and examples thereof include sulfur components such as powdered sulfur, precipitated sulfur, colloidal sulfur, insoluble sulfur, and highly dispersible sulfur. The content of the sulfur is not particularly limited as long as it satisfies the Expression (1), and is, for example, preferably 0.1 parts by mass to 8 parts by mass, and more preferably 1 part by mass to 5 parts by mass, with respect to 100 parts by mass of the diene rubber (U1).

The rubber composition (U) according to the present embodiment May further contain a vulcanization accelerator, and a content thereof is preferably 0.1 parts by mass to 5 parts by mass, and more preferably 0.2 parts by mass to 3 parts by mass, with respect to 100 parts by mass of the diene rubber (U1). Examples of the vulcanization accelerator include a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamate-based vulcanization accelerator.

The rubber composition (U) according to the present embodiment may contain a reinforcing filler. As the reinforcing filler, carbon black and/or silica are preferably used. That is, as the reinforcing filler, carbon black may be used alone, silica may be used alone, or carbon black and silica may be used in combination. It is preferable that carbon black is used alone, or carbon black and silica are used in combination. A content of the reinforcing filler is not particularly limited, and is, for example, preferably 10 parts by mass to 100 parts by mass, more preferably 20 parts by mass to 80 parts by mass, and still more preferably 20 parts by mass to 60 parts by mass, with respect to 100 parts by mass of the diene rubber (U1).

The carbon black is not particularly limited, and various known types can be used. The content of the carbon black (CBU) is preferably 10 parts by mass to 100 parts by mass, and more preferably 20 parts by mass to 50 parts by mass, with respect to 100 parts by mass of the diene rubber (U1).

The silica is also not particularly limited, and wet silica such as silica made by a wet-type precipitated method or silica made by a wet-type gel-method is preferably used.

When the silica is compounded, the content thereof is preferably 0.1 parts by mass to 50 parts by mass, and more preferably 5 parts by mass to 30 parts by mass, with respect to 100 parts by mass of the diene rubber (U1).

<Rubber Composition (L) Used in Lower Bead Filler>

The rubber composition (L) according to the present embodiment contains the diene rubber (L1) as a rubber component, a type thereof is not particularly limited, and examples thereof include a natural rubber (NR), an isoprene rubber (IR), a butadiene rubber (BR), a styrene-butadiene rubber (SBR), a styrene-isoprene copolymer rubber, a butadiene-isoprene copolymer rubber, a styrene-isoprene-butadiene copolymer rubber, an acrylonitrile-butadiene rubber (NBR), a chloroprene rubber (CR), and a butyl rubber (IIR).

The rubber composition (L) according to the present embodiment contains the sulfur (L2), a type thereof is not particularly limited, and examples thereof include sulfur components such as powdered sulfur, precipitated sulfur, colloidal sulfur, insoluble sulfur, and highly dispersible sulfur. The content of the sulfur is not particularly limited as long as it satisfies the Expressions (1) and (2), and is, for example, preferably 1 part by mass to 15 parts by mass, and more preferably 5 parts by mass to 10 parts by mass, with respect to 100 parts by mass of the diene rubber (L1).

The rubber composition (L) according to the present embodiment may further contain a vulcanization accelerator, and a content thereof is preferably 0.1 parts by mass to 5 parts by mass, and more preferably 0.2 parts by mass to 3 parts by mass, with respect to 100 parts by mass of the diene rubber (L1). Examples of the vulcanization accelerator include a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamate-based vulcanization accelerator.

The rubber composition (L) according to the present embodiment may contain a reinforcing filler. As the reinforcing filler, carbon black and/or silica are preferably used. That is, as the reinforcing filler, carbon black may be used alone, silica may be used alone, or carbon black and silica may be used in combination. It is preferable that carbon black is used alone, or carbon black and silica are used in combination. A content of the reinforcing filler is not particularly limited, and is, for example, preferably 10 parts by mass to 140 parts by mass, more preferably 30 parts by mass to 100 parts by mass, and still more preferably 50 parts by mass to 100 parts by mass, with respect to 100 parts by mass of the diene rubber (L1).

The carbon black is not particularly limited, and various known types can be used. The content of the carbon black (CBL) is preferably 10 parts by mass to 140 parts by mass, and more preferably 50 parts by mass to 90 parts by mass, with respect to 100 parts by mass of the diene rubber (L1).

The silica is also not particularly limited, and wet silica such as silica made by a wet-type precipitated method or silica made by a wet-type gel-method is preferably used. When the silica is compounded, the content thereof is preferably 0.1 parts by mass to 80 parts by mass, and more preferably 5 parts by mass to 40 parts by mass, with respect to 100 parts by mass of the diene rubber (L1).

<Rubber Composition (P) Used in Second Pad>

The rubber composition (P) according to the present embodiment contains the diene rubber (P1) as a rubber component, a type thereof is not particularly limited, and examples thereof include a natural rubber (NR), an isoprene rubber (IR), a butadiene rubber (BR), a styrene-butadiene rubber (SBR), a styrene-isoprene copolymer rubber, a butadiene-isoprene copolymer rubber, a styrene-isoprene-butadiene copolymer rubber, an acrylonitrile-butadiene rubber (NBR), a chloroprene rubber (CR), and a butyl rubber (IIR).

The rubber composition (P) according to the present embodiment contains the sulfur (P2), a type thereof is not particularly limited, and examples thereof include sulfur components such as powdered sulfur, precipitated sulfur, colloidal sulfur, insoluble sulfur, and highly dispersible sulfur. The content of the sulfur is not particularly limited as long as it satisfies the Expression (2), and is, for example, preferably 0.1 parts by mass to 8 parts by mass, and more preferably 1 part by mass to 5 parts by mass, with respect to 100 parts by mass of the diene rubber (P1).

The rubber composition (P) according to the present embodiment may further contain a vulcanization accelerator, and a content thereof is preferably 0.1 parts by mass to 5 parts by mass, and more preferably 0.2 parts by mass to 3 parts by mass, with respect to 100 parts by mass of the diene rubber (P1). Examples of the vulcanization accelerator include a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamate-based vulcanization accelerator.

The rubber composition (P) according to the present embodiment may contain a reinforcing filler. As the reinforcing filler, carbon black and/or silica are preferably used. That is, as the reinforcing filler, carbon black may be used alone, silica may be used alone, or carbon black and silica may be used in combination. It is preferable that carbon black is used alone, or carbon black and silica are used in combination. A content of the reinforcing filler is not particularly limited, and is, for example, preferably 10 parts by mass to 100 parts by mass, more preferably 20 parts by mass to 80 parts by mass, and still more preferably 20 parts by mass to 60 parts by mass, with respect to 100 parts by mass of the diene rubber (P1).

The carbon black is not particularly limited, and various known types can be used. The content of the carbon black (CBP) is preferably 10 parts by mass to 100 parts by mass, and more preferably 30 parts by mass to 60 parts by mass, with respect to 100 parts by mass of the diene rubber (P1).

The silica is also not particularly limited, and wet silica such as silica made by a wet-type precipitated method or silica made by a wet-type gel-method is preferably used. When the silica is compounded, the content thereof is preferably 0.1 parts by mass to 50 parts by mass, and more preferably 5 parts by mass to 30 parts by mass, with respect to 100 parts by mass of the diene rubber (P1).

In addition to the above components, compounding chemicals such as a process oil, a softener, a plasticizer, a wax, and an antiaging agent, which are generally used in the rubber industry, can be appropriately compounded within a normal range in the rubber composition (U), the rubber composition (L), and the rubber composition (P) according to the present embodiment.

The rubber composition (U), the rubber composition (L), and the rubber composition (P) according to the present embodiment can be produced by kneading according to a common method by using a mixer such as a Banbury mixer, a kneader, or a roll that is generally used. That is, for example, in a first mixing stage, an additive other than a vulcanization agent and a vulcanization accelerator is added to and mixed with the diene rubber, and then in a final mixing stage, the vulcanization agent and the vulcanization accelerator are added to and mixed with the obtained mixture to prepare a rubber composition.

A method for manufacturing a pneumatic tire according to the present embodiment is not particularly limited as long as the rubber composition (U) obtained by the above-described method is used in the upper bead filler 222, the rubber composition (L) obtained by the above-described method is used in the lower bead filler 221, and the rubber composition (P) obtained by the above-described method is used in the second pad 36, and the pneumatic tire can be manufactured by a well-known method in the related art.

The pneumatic tire according to the present embodiment can be used for various vehicles such as a passenger car, and can be suitably used as a heavy-duty tire for a truck, a bus, a construction vehicle, an industrial vehicle, and the like because of having excellent bead durability.

### EXAMPLES

Hereinafter, Examples of the invention will be illustrated, but the invention is not limited to these Examples.

According to compounding (part by mass) shown in Table 1 below, using a Banbury mixer, first, in a first mixing stage, components except sulfur and a vulcanization accelerator were added and mixed (discharge temperature=160° C.), and then in a second mixing stage, the sulfur and the vulcanization accelerator were added to and mixed with the obtained mixture (discharge temperature=90° C.) to prepare a rubber composition.

Details of each component in Table 1 are as follows.
Natural rubber: RSS #3
Carbon black: “SEAST 3” manufactured by Tokai Carbon Co., Ltd.
Zinc oxide: “Zinc Oxide Grade 3” manufactured by MITSUI MINING & SMELTING CO., LTD.
Stearic acid: “Stearic Acid Bead” manufactured by NOF CORPORATION
Antiaging agent: “NOCRAC 6C” manufactured by Ouchi SHINKO CHEMICAL INDUSTRIAL CO., LTD.
Oil: “NC-140” manufactured by ENEOS Corporation
Sulfur: “MUCRON OT-20” manufactured by SHIKOKU CHEMICALS CORPORATION
Vulcanization accelerator: “SANCELER NS-G” manufactured by Sanshin Chemical Industry Co., Ltd.

The obtained rubber compositions were used to produce a pneumatic tire (tire size: 11R22.5 14PR) by combining the rubber compositions shown in Table 2. The obtained pneumatic tire was evaluated for durability before aging and durability after aging according to the following evaluation methods. Table 2 shows the evaluation results.
Durability before aging: the obtained pneumatic tire was run on a drum tester under conditions of an internal air pressure of 900 kPa, a load of 5400 kg, and a speed of 40 km/h until a bead portion failed, and the running time was taken as the bead durability. Comparative Example 1 was used as a control, and a longer running time was evaluated as “A”, a same running time was evaluated as “B”, and a shorter running time was evaluated as “C”.
Durability after aging: the obtained pneumatic tire was heat-aged in an oven at 70° C. for 4 weeks, and the durability after aging was evaluated in the same manner as the durability before aging.

TABLE 1

| | Compound- | Compound- | Compound- | Compound- | Compound- | Compound- | Compound- | Compound- | Compound- |
|---|---|---|---|---|---|---|---|---|---|
| | ing 1 | ing 2 | ing 3 | ing 11 | ing 12 | ing 13 | ing A | ing B | ing C |
| Natural rubber | 100 | 100 | 100 | 100 | 100 | 100 | 100 | 100 | 100 |
| Carbon black | 75 | 80 | 75 | 40 | 30 | 40 | 50 | 50 | 40 |
| Zinc oxide | 6 | 6 | 6 | 6 | 6 | 6 | 6 | 6 | 6 |
| Stearic acid | 2 | 2 | 2 | 2 | 2 | 2 | 2 | 2 | 2 |
| Antiaging agent | 1 | 1 | 1 | 1 | 1 | 1 | 1 | 1 | 1 |
| Oil | 4 | 4 | 4 | 4 | 4 | 4 | 4 | 4 | 4 |
| Sulfur | 10 | 10 | 7 | 5 | 3.5 | 2 | 5 | 4 | 2 |
| Vulcanization | 1.5 | 1.5 | 1.5 | 1.5 | 1.5 | 1.5 | 1.5 | 1.5 | 1.5 |
| accelerator | | | | | | | | | |

TABLE 2

| | Comparative | Comparative | Comparative | Comparative | Comparative | | | | |
|---|---|---|---|---|---|---|---|---|---|
| | Example 1 | Example 2 | Example 3 | Example 4 | Example 5 | Example 1 | Example 2 | Example 3 | Example 4 |
| Lower | Compound- | Compound- | Compound- | Compound- | Compound- | Compound- | Compound- | Compound- | Compound- |
| bead | ing 3 | ing 1 | ing 1 | ing 2 | ing 3 | ing 1 | ing 1 | ing 1 | ing 2 |
| Upper | Compound- | Compound- | Compound- | Compound- | Compound- | Compound- | Compound- | Compound- | Compound- |
| bead | ing 11 | ing 13 | ing 11 | ing 13 | ing 11 | ing 11 | ing 11 | ing 12 | ing 12 |
| Second | — | Compound- | Compound- | Compound- | Compound- | Compound- | Compound- | Compound- | Compound- |
| pad | | ing C | ing C | ing A | ing B | ing A | ing B | ing B | ing B |
| LS-US | 2 | 8 | 5 | 8 | 2 | 5 | 5 | 6.5 | 6.5 |
| LS-PS | — | 8 | 8 | 5 | 3 | 5 | 6 | 6 | 6 |
| Durability | — | B | B | B | B | A | A | A | A |
| before | | | | | | | | | |
| aging | | | | | | | | | |
| Durability | — | C | B | B | B | A | A | A | A |
| after | | | | | | | | | |
| aging | | | | | | | | | |

As shown in Table 2, Comparative Example 1 is an example having no pad. Comparative Example 2 is an example in which LS-US and LS-PS each exceed an upper limit value, and the durability after aging is poor.

Comparative Example 3 is an example in which LS-PS exceeds the upper limit value, and the durability before aging and the durability after aging are not improved.

Comparative Example 4 is an example in which LS-US exceeds the upper limit value, and the durability before aging and the durability after aging are not improved.

Comparative Example 5 is an example in which LS-US and LS-PS are each less than a lower limit value, and the durability before aging and the durability after aging are not improved.

On the other hand, in Examples 1 to 4, LS-US and LS-PS are each within a predetermined range, and the durability before aging and the durability after aging are excellent.

### INDUSTRIAL APPLICABILITY

The pneumatic tire according to the invention can be used as a passenger car tire or a large-sized tire for a truck or a bus.

### REFERENCE SIGNS LIST

1: tire
11: bead
12: tread
13: sidewall
21: bead core
22: bead filler
221: lower bead filler
222: upper bead filler
23: carcass ply
24: ply body
25: ply folded portion
25A: folded end
26: steel belt
28: tread rubber
29: inner liner
30: sidewall rubber
30B: tire radially inner end
31: steel chafer
31A: end portion of steel chafer
32: rim strip rubber
32A: tire radially outer end
34: pad member
35: first pad
36: second pad
36A: tire radially outer end
36B: tire radially inner end

What is claimed is:

1. A pneumatic tire comprising:
a bead filler including two members, an upper bead filler and a lower bead filler; and
a pad sandwiched between the upper bead filler and a sidewall and extending to a radially outer side of the upper bead filler, wherein
a rubber composition (U) containing a diene rubber (U1) and sulfur (U2) is used in the upper bead filler,
a rubber composition (L) containing a diene rubber (L1) and sulfur (L2) is used in the lower bead filler,
a rubber composition (P) containing a diene rubber (P1) and sulfur (P2) is used in the pad, and
a content of the sulfur (U2) (US [parts by mass]) with respect to 100 parts by mass of the diene rubber (U1) in the rubber composition (U),
a content of the sulfur (L2) (LS [parts by mass]) with respect to 100 parts by mass of the diene rubber (L1) in the rubber composition (L), and
a content of the sulfur (P2) (PS [parts by mass]) with respect to 100 parts by mass of the diene rubber (P1) in the rubber composition (P) satisfy the following Expressions (1) and (2):
4.0<LS-US<7.0 Expression (1)
4.0<LS-PS<7.0 Expression (2)

2. The pneumatic tire according to claim 1, wherein
a content of carbon black (CBU [parts by mass]) with respect to 100 parts by mass of the diene rubber (U1) in the rubber composition (U),
a content of carbon black (CBL [parts by mass]) with respect to 100 parts by mass of the diene rubber (L1) in the rubber composition (L), and
a content of carbon black (CBP [parts by mass]) with respect to 100 parts by mass of the diene rubber (P1) in the rubber composition (P) satisfy the following Expression (3):
CBL>CBP>CBU. Expression (3)

3. The pneumatic tire according to claim 1, wherein
the content of the sulfur (US) in the rubber composition (U) and the content of the sulfur (PS) in the rubber composition (P) satisfy the following Expression (4):
−1.0<US-PS<2.0 Expression (4)

4. The pneumatic tire according to claim 2, wherein
the content of the sulfur (US) in the rubber composition (U) and the content of the sulfur (PS) in the rubber composition (P) satisfy the following Expression (4):
−1.0<US-PS<2.0 Expression (4)

5. The pneumatic tire according to claim 1, which is a heavy-duty pneumatic tire.

6. The pneumatic tire according to claim 2, which is a heavy-duty pneumatic tire.

7. The pneumatic tire according to claim 3, which is a heavy-duty pneumatic tire.

8. The pneumatic tire according to claim 4, which is a heavy-duty pneumatic tire.
